(19) United States
(12) Patent Application Publication
(10) Pub. No.: US 2005/0278196 A1
(43) Pub. Date: Dec. 15, 2005

(54) System and method for developing and utilizing member condition groups

(76) Inventors: Sreedhar V. Potarazu, Potomac, MD (US); Sudhir Anandarao, Vienna, VA (US); Lawrence N. Croney, Springfield, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/863,819

(22) Filed: Jun. 9, 2004

(51) Int. Cl. G06F 17/60

(52) U.S. Cl. 705/2; 705/4

(57) ABSTRACT

A system and method for developing and utilizing member condition groups (MCGs) determines whether an individual has been diagnosed with one or more diagnostic codes from a predetermined group of diagnostic codes. Each diagnosed individual is associated, based on the one or more diagnostic codes, with one or more member condition groups (MCGs), each MCG representing a group of individuals diagnosed with clinically related diagnostic codes. A healthcare-related cost, including a pharmacy cost, a disability benefit, a workers compensation benefit, a health benefit administration fee, or an absence cost, associated with each diagnosed individual from a predetermined MCG during a predetermined time period is determined. Additionally, a medical health benefits cost, which is distinct from the healthcare-related cost, can be determined for each diagnosed individual. The medical health benefits cost and the healthcare-related cost can be combined to determine a comprehensive healthcare cost associated with each diagnosed individual.

### FIELD OF THE INVENTION

The invention relates generally to healthcare-related benefits and other benefits. More specifically, the invention relates to member condition groups (MCGs) associated with healthcare-related benefits and other benefits.

### BACKGROUND

As insurance and other health-related costs have increased, the importance of and demand for healthcare-related cost analysis and management tools has increased dramatically in recent years. Medical health benefits costs, such as insurance benefits costs, and other costs directly related to treatment have increased at a rate that many consider alarming. Moreover, healthcare-related costs other than medical health benefits costs have also increased significantly.

Adding to the general concerns about increasing healthcare costs is the fact that healthcare costs are not evenly distributed over the population. Some estimates suggest that a segment of the population as small as one percent accounts for as much as thirty percent of the total number of healthcare dollars spent in the United States. These same estimates indicate that ten percent of the population accounts for about seventy-two percent of the total number of healthcare dollars spent, while fifty percent of the population accounts for a staggering estimated ninety-seven percent of the total number of healthcare dollars spent in the United States.

Because of the increasing costs of medical health benefits, and because of the propensity of a small percentage of the population to drive a large percentage of these costs, a variety of tools have been developed to help interested parties (e.g., healthcare plan administrators, employers, etc.) analyze and manage healthcare costs.

Adjusted Clinical Groups (ACGs), which were formerly known as Ambulatory Care Groups, are one tool for analyzing healthcare costs. ACGs, which were developed by Johns Hopkins University, are part of a system that is used to classify healthcare conditions. ACGs are mutually exclusive health status categories that are defined by morbidity, age, and gender. ACGs allow segmentation by member based on severity of illness and comorbidity, but not by disease condition.

Population risk-assessment techniques known as Diagnostic Cost Groups (DCGs) have been developed by DxCG, Inc., of Boston, Mass. DCGs use risk-assessment and risk-adjustment techniques to analyze and attempt to predict future use of healthcare resources by an individual (e.g., a member of a healthcare plan). DCGs do not, however, focus on disease conditions of an individual, or allow segmentation of individuals according to disease conditions.

Other techniques have also been developed that allow analysis of healthcare conditions and allow segmentation by conditions (e.g., diseases) at the episode level. For example, one known episode-level technique involves the use of episode treatment groups (ETGs) developed by Symmetry Health Data Systems. Such episode-level techniques, however, allow segmentation and analysis of costs, benefits, and diagnosis data on an episode level only, and not on an individual level.

Existing approaches for analyzing healthcare costs generally focus only on medical health benefits costs, such as insurance benefits costs and costs that are directly related to treatment (e.g., costs of doctor appointments, hospital visits, etc.), without taking into account other healthcare-related costs. For example, while some known techniques provide the ability to determine total medical costs (e.g., physician visits, hospital visits, etc.), those medical costs when combined with related pharmacy costs generally only account for approximately fifty-five percent of the total cost of a health condition.

As described above, existing approaches for analyzing healthcare conditions do not focus on analysis at an individual level at all, and/or do not allow for segmentation of members of a healthcare plan by disease condition. Therefore, such prior approaches are inadequate for describing a comprehensive healthcare cost associated with an individual (e.g. a healthcare plan member).

Accordingly, the ability to analyze healthcare conditions and healthcare-related costs on an individual basis and by disease condition is desirable. Additionally, the ability to determine and analyze a comprehensive healthcare cost, which includes healthcare-related costs other than medical health benefits costs, associated with each individual in a benefit group is desirable.

### SUMMARY

One or more embodiments of the invention provide a system and method for developing and utilizing member condition groups (MCGs), which facilitate analysis of healthcare conditions and healthcare-related costs on an individual basis and by disease condition. MCGs also provide the ability to determine and analyze a comprehensive healthcare cost associated with each individual (e.g., member) in a benefit group (e.g., a healthcare plan).

According to an embodiment of the invention, for each individual from a group of individuals, it is determined if that individual has been diagnosed with one or more diagnostic codes from a predetermined group of diagnostic codes, such as an international classification of diseases code (e.g., ICD-9 codes, etc.). Each diagnosed individual is associated with one or more member condition groups (MCGs) based on the one or more diagnostic codes with which the individual has been diagnosed. Each MCG represents a group of individuals diagnosed with clinically related diagnostic codes. A healthcare-related cost associated with each diagnosed individual from a predetermined MCG during a predetermined time period is determined. The healthcare-related cost includes at least one cost selected from a group including a pharmacy cost, a disability benefit, a workers compensation benefit, a health benefit administration fee, and an absence cost. Additionally, a medical health benefits cost associated with each diagnosed individual from the predetermined MCG during the predetermined time period can be determined. The medical health benefits cost is distinct from the healthcare-related cost. The medical health benefits cost and the healthcare-related cost can be combined to determine a comprehensive healthcare cost associated with each diagnosed individual.

According to another embodiment of the invention, a data model is provided including several data tables. The data model includes at least one member data table configured to store data representing multiple members of a healthcare plan. The data model also includes at least one health-condition data table configured to store data representing health-condition information of each member from the multiple members. The health-condition information is configured to include multiple diagnostic codes for each member from the multiple members. The data model also includes at least one member-group data table configured to relate, for each member, a diagnostic code from the multiple diagnostic codes to a member condition group (MCG) of clinically related diagnostic codes, if it is determined that the diagnostic code includes a predetermined diagnostic code.

Other advantages and features associated with embodiments of the invention will become more readily apparent to those skilled in the art from the following detailed description. As will be realized, the invention is capable of other and different embodiments, and its several details are capable of modification in various aspects, all without departing from the invention. Accordingly, the drawings and the description are to be regarded as illustrative in nature, and not limiting.

### BRIEF DESCRIPTION OF THE DRAWINGS

FIG. 1 is a block diagram showing known expanded diagnostic clusters (EDCs).

FIG. 2 is a block diagram showing an example of an expanded diagnostic cluster (EDC).

FIG. 3 is a block diagram showing known aggregated diagnostic groups (ADGs) and adjusted clinical groups (ACGs).

FIG. 4 is a block diagram showing member condition groups (MCGs), according to an embodiment of the invention.

FIG. 5 is a block diagram showing an example of a member condition group (MCG), according to an embodiment of the invention.

FIG. 6 is a block diagram showing an example of a computer network system, according to an embodiment of the invention.

FIG. 7 is a flow diagram of a process, according to an embodiment of the invention.

FIG. 8 is a block diagram showing an example of costs, according to an embodiment of the invention.

FIG. 9 is a block diagram of a data model, according to an embodiment of the invention.

### DETAILED DESCRIPTION

One or more systems and methods for developing and using member condition groups (MCGs) are described. More specifically, an embodiment of the invention is described in the context of a system and method configured to segregate and analyze medical health benefits costs and healthcare-related costs on an individual basis and/or by disease condition. An embodiment of the invention includes a system and method that has the ability to determine and analyze a comprehensive healthcare cost, including costs other than medical health benefits costs, associated with each individual in a clinically related group (e.g., an MCG).

As used herein, the term “healthcare plan” (which is sometimes referred to as a “health plan,” “benefit plan,” or “beneficiary plan”) means a system by which one or more individuals are provided with healthcare treatment or other health-related or well-being-related treatment. A health care plan can include, for example, one or more benefit plans, such as an insurance plan, a retirement plan, a pension plan, a workers compensation plan, a disability plan, a medical plan, a pharmacy plan, a dental plan, a vision plan, a medical leave plan, a maternity/paternity plan, and/or other similar plans or plans that provide similar types of benefits. A healthcare plan can be administered, sponsored, or provided by insurance companies, employers, non-profit organizations, or other entities having an interest in providing the related benefits of the healthcare plan. A healthcare plan does not need to be administered, sponsored, or provided by the same entity.

As used herein, the term “member” means any individual eligible to receive benefits from a healthcare plan. Generally, to be eligible to receive benefits from a healthcare plan, a member must be enrolled within that healthcare plan, according to the rules of the healthcare plan. Members can also be referred to as “beneficiaries,” inasmuch as they receive benefits from the healthcare plan. A “member population” is a group of members eligible to receive benefits from a common healthcare plan.

According to one or more embodiments of the invention, a new type of grouping methodology, called member condition groups (MCGs) has been developed. As used herein, the term “member condition group” or “MCG” refers to a group of one or more members that have been diagnosed with one or more clinically related healthcare conditions. MCGs allow reporting and/or analysis of the impact of specific conditions on individual members, on a group of members, on a member population as a whole, or on a healthcare plan in which the individual member is participating, or enrolled. This type of segmentation is useful for disease management, case-mix analysis, benefits modeling, needs assessment, quality measurement, and disease burden benchmark analysis. More specifically, MCGs allow identification of individuals with specific healthcare conditions of interest (e.g., to a healthcare plan administrator, etc.), and facilitate analysis of any impact of those individuals on a healthcare plan in which they are members.

MCGs are advantageous in that they correspond to a set of individuals that have a particular disease. Because MCGs are not mutually exclusive, multiple MCGs can be associated with a single individual (e.g., a member) simultaneously and, therefore, they are capable of providing a more complete picture of the overall health profile of that individual, as well as the overall costs of that individual to himself or to a healthcare plan administrator or provider (e.g., an employer). MCGs can focus on specific conditions that make up a large portion of healthcare costs, and can focus on other factors of interest to a healthcare plan provider or administrator, such as specific conditions that respond well to disease management programs. Thus, each individual in a healthcare plan may not be assigned an MCG, such that MCGs may not be all-inclusive of all members in all healthcare plans, depending upon the desired analysis to be undertaken using the MCGs.

MCGs also can be readily used with existing healthcare and diagnostic-analysis tools. Thus, techniques that indicate the severity of an illness, or the comorbidity of a disease condition can be used with MCGs. For example, MCGs could be used with such techniques (e.g., ACGs) to determine if members having a particular disease condition of interest (e.g., as indicated by MCGs) may also be considered a high-risk individual, or considered as having a high-risk condition. Additionally, using MCGs, multiple unions between different criteria are possible because MCGs are not mutually exclusive, and thus MCGs can provide a more comprehensive and inclusive picture of an individual's health condition profile.

Various codes for representing different diseases and disease classifications have been developed. One standard for classifying diseases is known as the International Classification of Diseases (ICD) system. The ICD system is a statistical classification system that includes a group of identifying codes for reporting diagnosis information of healthcare plan enrollees. These codes are used by a healthcare provider (e.g., a physician, dentist, etc.) to report the provider's diagnosis of an individual, for example, when an insurance claim is submitted. Each code within the ICD classification system has a corresponding health condition or diagnosis, which is known by healthcare plan administrators and can be determined when the ICD code is reported by a healthcare provider.

In the United States, the ICD classification system is currently in its ninth revision, and codes from the current revision are often referred to as ICD-9 or ICD-9-CM codes. Generally, to provide an accurate diagnosis of an individual, a healthcare provider will indicate several ICD codes for that individual (e.g., a primary diagnosis code, a secondary diagnosis code, a tertiary diagnosis code, etc.). The use of ICD codes is widespread and well understood by people in the healthcare industry, such as plan administrators, insurance officials, employers, and so forth. Additionally, some government-sponsored healthcare plans, such as Medicare or Medicaid, require the use of ICD codes.

One problem with using ICD codes, however, is that they are so numerous because the ICD classification system focuses on the accuracy of each individual diagnosis. There are more than 14,000 ICD codes in the ICD classification system, which makes analyzing diagnoses using those codes (e.g., for the purpose of implementing a disease-management program) unwieldy for healthcare plan administrators. Because of the difficulty in effectively using ICD codes, multiple paradigms for simplifying and/or consolidating diagnosis codes, such as ICD codes, have been developed.

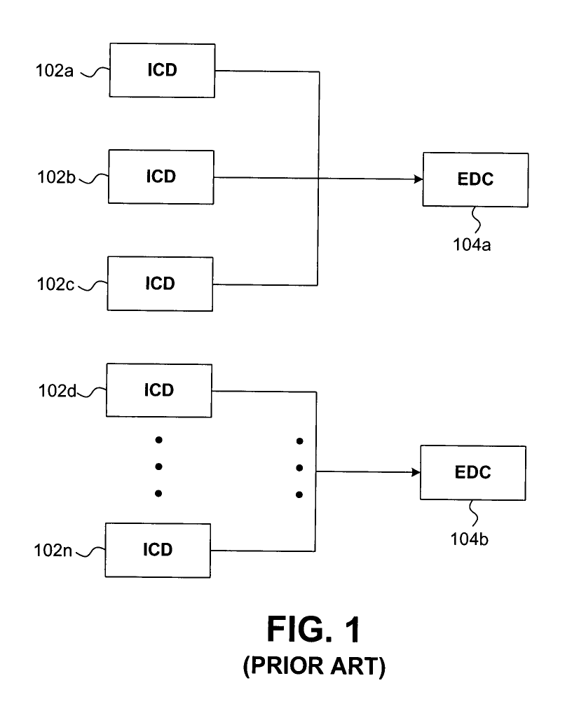

FIG. 1 is a block diagram showing known expanded diagnostic clusters (EDCs), which is a diagnostic classification system developed by Johns Hopkins University. EDCs, which are sometimes referred to as dino-clusters, are one technique for consolidating ICD codes. In FIG. 1, multiple ICD codes 102a, 102b, 102c, 102d, . . . , 102n are shown. These ICD codes can be, for example, ICD-9 codes associated with the most recent, ninth revision of the ICD classification system. Alternatively, the ICD codes 102a-102n can also represent codes from other revisions of the ICD classification system.

Two EDCs 104a, 104b are shown in FIG. 1, each of which corresponds to one or more diagnostically similar ICD codes 102. It should be noted that multiple ICD codes 102 generally correspond to a single EDC 104. Thus, a single EDC can represent many similar diagnoses (e.g., as identified by multiple ICD codes) of an individual from one or more healthcare providers. Using EDCs is advantageous, as there are far fewer EDCs (about 190) than there are ICD codes (over 14,000). Additionally, EDCs can be further consolidated into major EDCs (MEDCs), of which there are approximately 27 (not shown). These MEDCs can be categorized into five major EDC types.

As mentioned above, ICD codes 102 are grouped into EDCs 104 based on diagnostic similarities. Thus, ICD codes 102 that relate to very similar diagnoses, or similar conditions, may correspond to a single EDC 104. For example, as shown in FIG. 1, the first three ICD codes 102a, 102b, 102c, are diagnostically similar, and are categorized in a single EDC 104a. An individual can be simultaneously diagnosed with conditions from multiple EDCs 104; however, EDCs are used only to group ICD codes, and do not themselves relate directly to individuals (e.g., members).

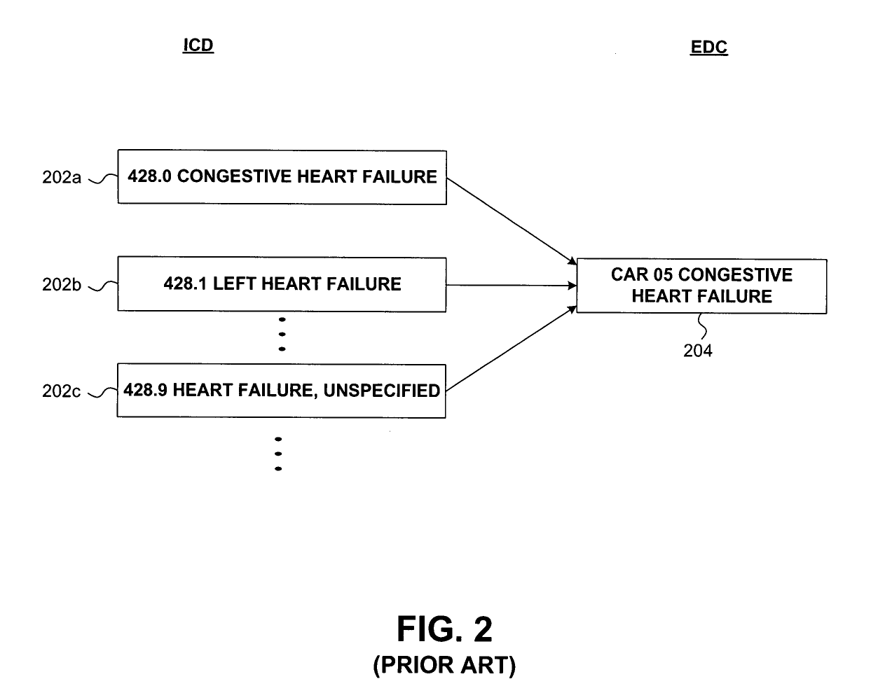

FIG. 2 is a block diagram showing an example of an expanded diagnostic cluster (EDC). In FIG. 2, three ICD codes 202a, 202b, 202c are shown as relating to a single EDC 204. It should be recognized that the ICD codes 202a, 202b, 202c shown in FIG. 2 are not an exhaustive list of the ICD codes associated with the specific EDC 204 shown in FIG. 2, but rather a subset thereof. In FIG. 2, three diagnostically similar ICD codes 202a, 202b, 202c, which relate to “428.0 Congestive Heart Failure,” “428.1 Left Heart Failure,” and “428.9 Heart Failure, Unspecified,” respectively, are shown as corresponding to the single EDC for “CAR 05 Congestive Heart Failure” 204.

According to one or more embodiments of the invention, ICDs, EDCs, or other diagnostic codes can be used as input to describe diagnostic information in preparation for developing and utilizing MCGs.

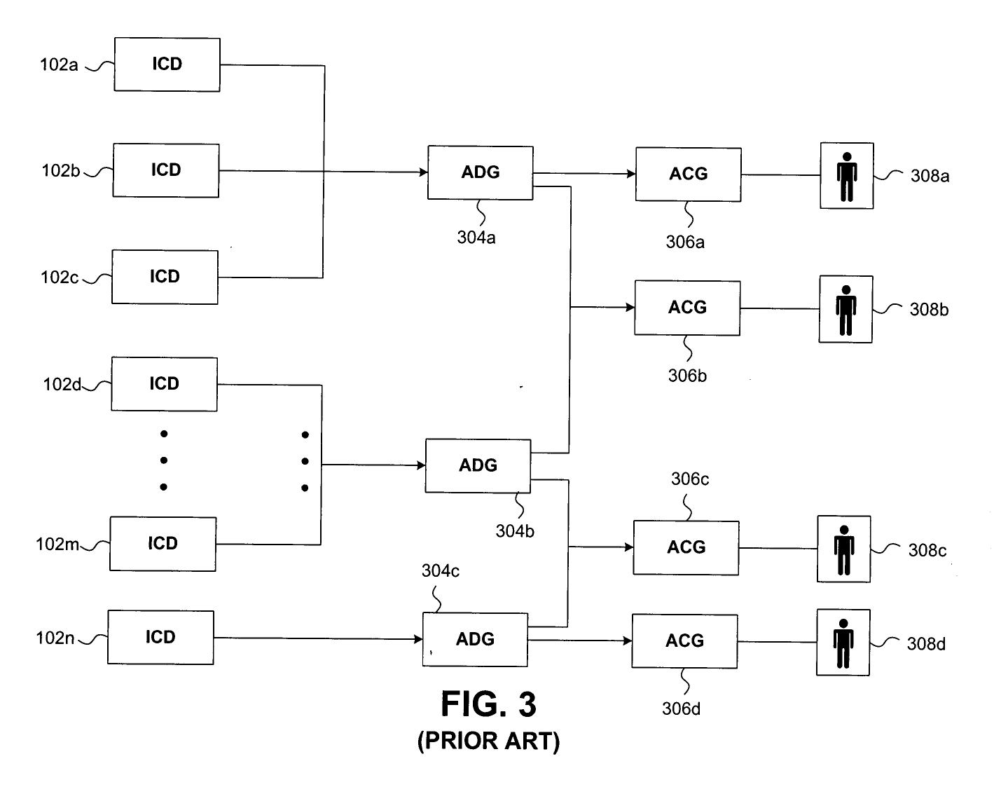

FIG. 3 is a block diagram showing known aggregated diagnostic groups (ADGs) and Adjusted Clinical Groups (ACGs). As described above, ACGs, which were formerly known as Ambulatory Care Groups, are mutually exclusive health status categories defined by morbidity, age, and gender. ACGs are useful for segmenting a beneficiary population (e.g., a healthcare-plan-member population) on the basis of severity of an illness and/or comorbidity. Aggregated diagnostic groups (ADGs) are used in conjunction with demographic information to create ACGs from ICDs.

As shown in FIG. 3, multiple ICD codes 102a, 102b, 102c, 102d, . . . , 102m, 102n are shown. Each of the ICD codes relates to a single ADG from the group of ADGs 304a, 304b, 304c shown in FIG. 3 based on clinical criteria related to healthcare needs. Thus, each ICD associated with an ADG does not have to be diagnostically related to another ICD assigned to the same ADG. Each ICD code 102 is assigned to a single ADG 304 on the basis of several criteria, including: duration, severity, diagnostic certainty, etiology, and expected need for specialty care. There is a total of thirty-two ADGs, each ADG corresponding to one of the possible permutations of these five criteria.

The thirty-two ADGs 304 are related to one of ninety-three existing ACGs 306 in a variety of ways, including one-to-one relationships, one-to-many relationships, and many-to-one relationships. Thus, a single ACG, such as 306a, can be related to a single ADG 304a. Alternatively, a single ACG, such as ACG 306b, can be related to multiple ADGs, such as the first ADG 304a and the second ADG 304b. ACGs focus on combinations of the five criteria, and the interplay between one or more ADGs, that are of interest to a healthcare provider.

Each ACG 306 is mutually exclusive of other ACGs. Thus, each individual 308a-308d within a member population can be assigned only a single ACG 306 at any given time. MCGs, according to one or more embodiments of the invention, are complementary to and do not supplant the capabilities of ACGs.

According to one or more embodiments of the invention, MCGs are different from ACGs in several important ways. For example, MCGs are not mutually exclusive and, therefore, may provide a more comprehensive profile of an individual than is possible using ACGs. Additionally, MCGs are groups of individuals with similar diagnoses, whereas ACGs are groups of individuals with similar levels of risk.

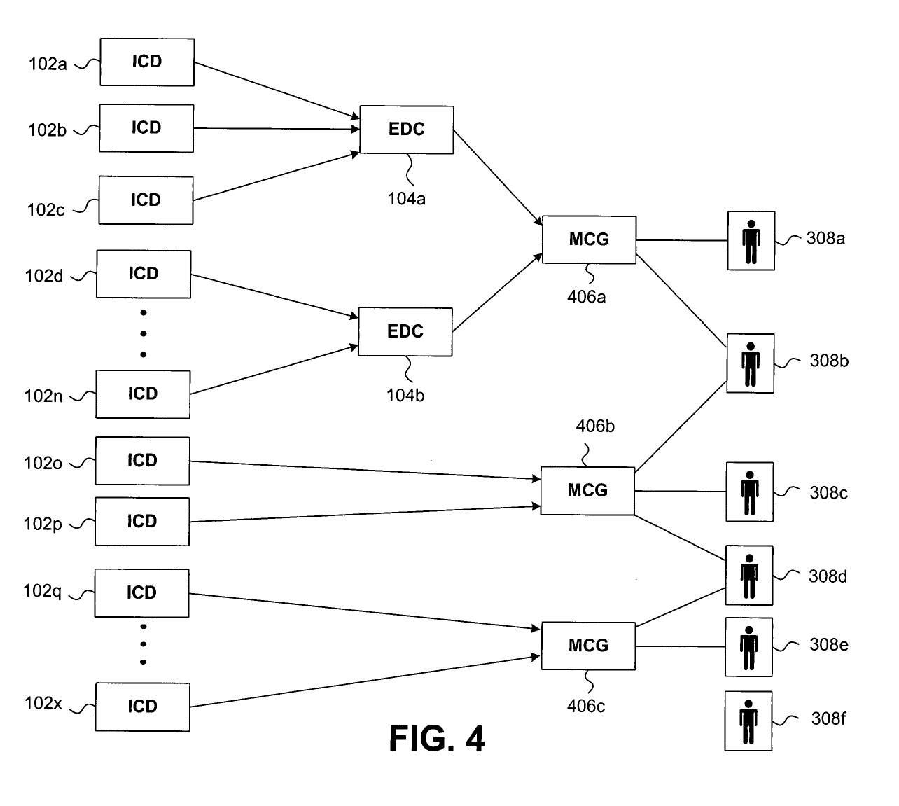

FIG. 4 is a block diagram showing member condition groups (MCGs), according to an embodiment of the invention. As mentioned above, MCGs overcome some of the problems with existing diagnostic analysis tools, such as those described above.

Specifically, MCGs, according to one or more embodiments of the invention, provide an overall or comprehensive view of a cost of an individual within a member population, or within a healthcare plan. This information is provided at an individual level, rather than at an episode level or a disease level. Additionally, according to one or more embodiments of the invention, a comprehensive healthcare cost that includes both medical health benefits costs and other healthcare-related costs can be determined using MCGs. Unlike some prior approaches, MCGs are not mutually exclusive, and therefore can help provide a more detailed and complete view of an individual's health condition. Additionally, MCGs, according to one or more embodiments of the invention, are not limited to characterization of a single disease, such that they can provide multi-dimensional information about the condition of a member within a healthcare plan.

In FIG. 4, ICD codes 102a-102×, EDCs 104a, 104b, or other similar diagnostic codes can be used to create MCGs 406a, 406b, 406c according to one or more embodiments of the invention. For example, MCGs, such as the first MCG 406a, can include or be defined by one or more EDCs, such as the first and second EDC 104a, 104b, respectively. Likewise, as shown in FIG. 4, each MCG 406 can be defined based on ICD codes 102, either as they relate to EDCs 104, or independently.

MCGs 406 are not mutually exclusive, and therefore each individual 308a-308e in a member population can be associated with one or more MCGs 406a-406c. MCGs 406 are generally created for specific conditions that make up a large portion of healthcare costs. Additionally, MCGs 406 can be used for conditions that respond well to disease management programs, or the like. Thus, MCGs 406 are not necessarily all inclusive, and an individual, such as the last individual 308f shown, within a member population may not be assigned an MCG 406 at all. MCGs 406 are clinically related and therefore the diagnostic codes that make up the MCGs 406 may be closely clinically related. This may or may not mean that the diagnostic codes that define an MCG are diagnostically related, as is the case with EDCs 104. Instead, diagnostic codes (e.g., ICDs 102, EDCs 104, etc.) that make up MCGs 406 may be related on the basis of factors other than diagnostic data.

For example, if a diagnostic code is closely related pharmacologically with another diagnostic code, it can correspond to the same MCG, even if the diagnostic relationship between the two pharmacologically related diagnostic codes might not cause the two codes otherwise to be grouped together. Such a comparison can be made, for example, using one or more common drug codes, such as a national drug code (NDC), or the like. For example, a drug such as finasteride can be prescribed to treat two totally unrelated health conditions (male pattern baldness and benign prostatic hypertrophy) which are unrelated diagnostically, but are related pharmacologically, and may present some of the same pharmacy cost considerations, or other considerations. Whether diagnostic codes are grouped together in an MCG may depend, for example, on business rules set up to determine each MCG, or on the magnitude of the costs associated with the diagnostic condition, such as pharmacy-related costs associated with a specific condition. Thus, MCGs are flexible enough to allow healthcare plan administrators or others to specify desired relationships to highlight important relationships between multiple diagnostic conditions.

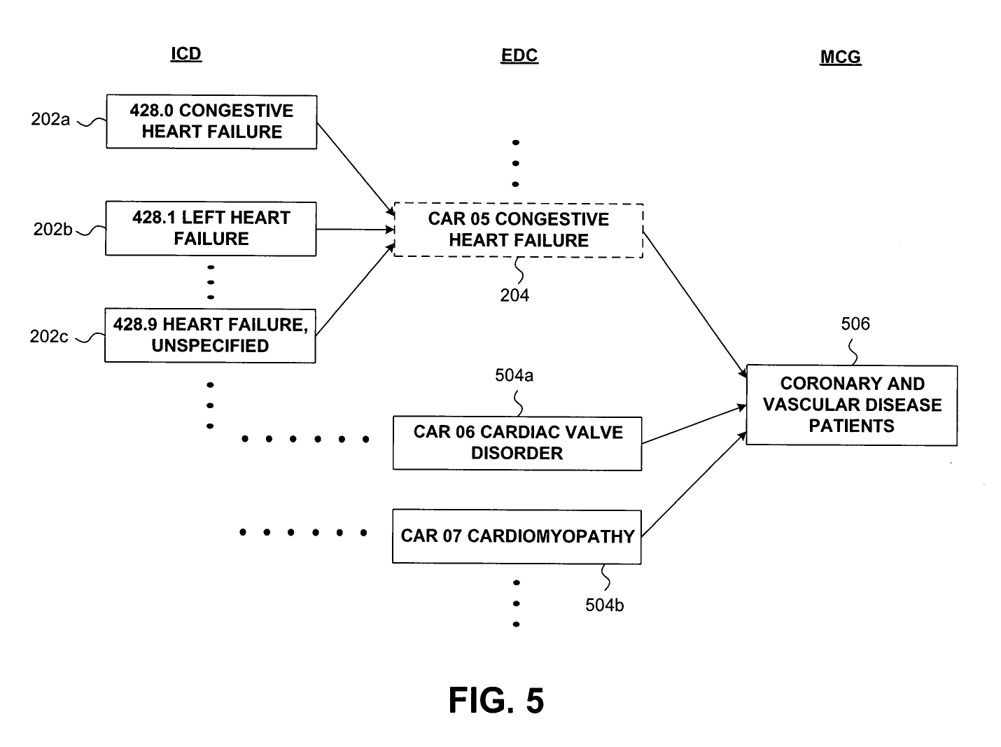

FIG. 5 is a block diagram showing an example of a member condition group (MCG), according to an embodiment of the invention. The example shown in FIG. 5 illustrates the fact that one or more diagnostic codes, such as ICD codes 202a, 202b, 202c, or such as EDCs 204, 504a, 504b can be used to form or define an MCG 506. In the example shown, the MCG 506 “Coronary and Vascular Disease Patients,” which represents a clinically related group of conditions, includes several related diagnostic codes, which may be related on the basis of parameters other than diagnostic similarity of the diagnostic codes (e.g., they may be based on a clinical relationship or similarity).

As shown in FIG. 5, an MCG 506 can be defined as including multiple EDCs (e.g., “CAR 05 Congestive Heart Failure” 204, “CAR 06 Cardiac Valve Disorder” 504a, “CAR 07 Cardiomyopathy” 504b, etc.) or multiple ICD codes (e.g., “428.0 Congestive Heart Failure” 202a, “428.1 Left Heart Failure,” “428.9 Heart Failure, Unspecified,” etc.), or some combination of the two. Additionally, diagnostic codes other than those discussed above or shown in FIG. 5, can be used to define MCGs 506. Moreover, custom groupings of diagnostic codes can be used to define an MCG 506 or partially define an MCG 506, depending upon the desires of a healthcare plan administrator or other interested party.

An example of MCGs, as well as corresponding definitions and EDCs can be seen below in Table 1. It should be noted that instead of EDCs, ICD codes or other diagnostic codes, can be used to form the definitions of MCGs in a manner similar to that shown in Table 1.

TABLE 1
MCGs and corresponding definitions and diagnostic codes

| MCG | Definition | Associated EDCs |
|---|---|---|
| Arthritics | At least one diagnosis | Autoimmune and Connective |
| | from the following | Tissue Diseases; Arthropathy; |
| | EDCs during a pre- | Gout; Raunaud's Syndrome; |
| | determined time | Degenerative Joint Disease |
| | period, excluding lab | |
| | and X-ray claims | |
| Asthmatics | At least one diagnosis | Asthma, w/o status asthmaticus; |
| | from the following | Asthma WITH status asthmaticus |
| | EDCs during a pre- | |
| | determined time | |
| | period, excluding lab | |
| | and X-ray claims | |
| Cancer | At least one diagnosis | All EDCs containing the word |
| Patients | from the following | “Malignant”; Acute Leukemia |
| | EDCs during a pre- | |
| | determined time | |
| | period, excluding lab | |
| | and X-ray claims | |
| Coronary | At least one diagnosis | Ischemic Heart Disease; |
| and | from the following | Cardiovascular Signs and |
| Vascular | EDCs during a pre- | Symptoms; Congenital Heart |
| Disease | determined time | Disease; Congestive Heart Failure; |
| Patients | period, excluding lab | Cardiac Valve Disorders; Cardio- |
| | and X-ray claims | myopathy; Heart Murmur; Cardiac |
| | | Arrythmia; Generalized Athero- |
| | | sclerosis; Disorders of Lipoid |
| | | Metabolism; Acute Myocardial |
| | | Infarction; Cardiac Arrest/Shock |
| Diabetics | At least one diagnosis | Type 2 diabetes w/o major |
| | from the following | complicating conditions; Type 2 |
| | EDCs during a pre- | diabetes WITH major complicating |
| | determined time | conditions; Type 1 diabetes w/o |
| | period, excluding lab | major complicating conditions; |
| | and X-ray claims | Type 1 diabetes WITH major |
| | | complicating conditions |
| Hypertension | At least one diagnosis | Hypertension, w/o major |
| Patients | from the following | complications; Hypertension, |
| | EDCs during a pre- | WITH major complications |
| | determined time | |
| | period, excluding lab | |
| | and X-ray claims | |
| Low Back | At least one diagnosis | Low Back Pain |
| Pain | from the following | |
| Patients | EDCs during a pre- | |
| | determined time | |
| | period, excluding lab | |
| | and X-ray claims | |
| Patients with | At least one diagnosis | Emphysema, Chronic Bronchitis, |
| Chronic | from the following | COPD |
| Pulmonary | EDCs during a pre- | |
| Diseases | determined time | |
| | period, excluding lab | |
| | and X-ray claims | |
| Patients with | At least one diagnosis | Anxiety and Neuroses; Depression; |
| Depression | from the following | Schizophrenia And Affective |
| and Other | EDCs during a pre- | Psychosis; Personality Disorders |
| Mental | determined time | |
| Conditions | period, excluding lab | |
| | and X-ray claims | |
| Patients with | At least one diagnosis | Acute Hepatitis; Chronic Liver |
| Ulcers and | from the following | Disease; Constipation; Diarrhea; |
| Other | EDCs during a pre- | Diverticular Disease of Colon; |
| Gastro- | determined time | Gastroesophageal Reflux; |
| intestinal | period, excluding lab | Gastrointestinal Signs and |
| Disorders | and X-ray claims | Symptoms; Inflammatory Bowel |
| | | Disease; Irritable Bowel |
| | | Syndrome; Peptic Ulcer Disease; |
| | | Acute Pancreatitis; Chronic |
| | | Pancreatitis |
| Pregnancies, | At least one diagnosis | Pregnancy and Delivery, |
| Uncompli- | from the following | Uncomplicated |
| cated | EDCs during a pre- | |
| | determined time | |
| | period, excluding lab | |
| | and X-ray claims | |
| | AND member is not | |
| | already in the “Preg- | |
| | nancies, With Compli- | |
| | cations” MCG, AND | |
| | Age Sub Group NOT | |
| | either equivalent to or | |
| | below a predetermined | |
| | age level. | |
| Pregnancies, | At least one diagnosis | Pregnancy and Delivery With |
| With | from the following | Complications; Complications of |
| Compli- | EDCs during a pre- | Pregnancy and Childbirth |
| cations | determined time | |
| | period, excluding lab | |
| | and X-ray claims | |
| | AND Age Sub Group | |
| | NOT either equivalent | |
| | to or below a predeter- | |
| | mined age level. | |
| Premature | At least one diagnosis | Prematurity (this is a custom group |
| Infants | from the following | of diagnostic codes, designed using |
| | EDCs during a pre- | business logic) |
| | determined time | |
| | period, excluding lab | |
| | and X-ray claims | |
| | AND Age Sub Group | |
| | either equivalent to or | |
| | below a predetermined | |
| | age level. | |

Table 1 identifies 13 MCGs and their corresponding definitions and diagnostic codes. These MCGs include clinically related EDCs, and may have special focus on high cost items, or items of concern. According to industry sources, the MCGs defined above in Table 1 include EDCs (and thus, the corresponding IDC codes) that account for up to 95% of all costs incurred either directly (e.g., as medical health benefits costs) or indirectly (e.g., as healthcare-related costs).

The definitions of MCGs can be changed, depending upon parameters important to a healthcare professional. For example, the definitions of many of the MCGs shown in Table 1 above explicitly state that the MCG excludes X-ray claims. Such definitions can be changed, however, according to one or more embodiments of the invention, using business logic, depending on the needs or desires of a healthcare plan administrator. Therefore, if X-ray expenses and corresponding X-ray claims were to begin to account for a large percentage of expenses in a given healthcare plan, the administrator of that healthcare plan may opt to include X-ray claims within the one or more MCGs. By including such information in one or more MCGs, X-ray costs and diagnoses associated with those costs could be more effectively tracked and managed, if desired. Similarly, other parameters used to define or associate diagnostic codes with MCGs can be altered using business logic as desired or needed.

Additionally, as is illustrated in the case of the “premature infants” MCG above in Table 1, diagnostic codes can be grouped together in any way desired by a healthcare plan administrator to form proprietary, or custom, groups of diagnostic codes (e.g., ICDs, EDCs, etc.). Moreover, additional MCGs not explicitly shown in Table 1 can be added as desired by a plan administrator. Thus, for example, if costs arising from treatment of a condition not specified in the table above become significant, a healthcare plan administrator can add an MCG, and define the corresponding diagnostic codes using business logic.

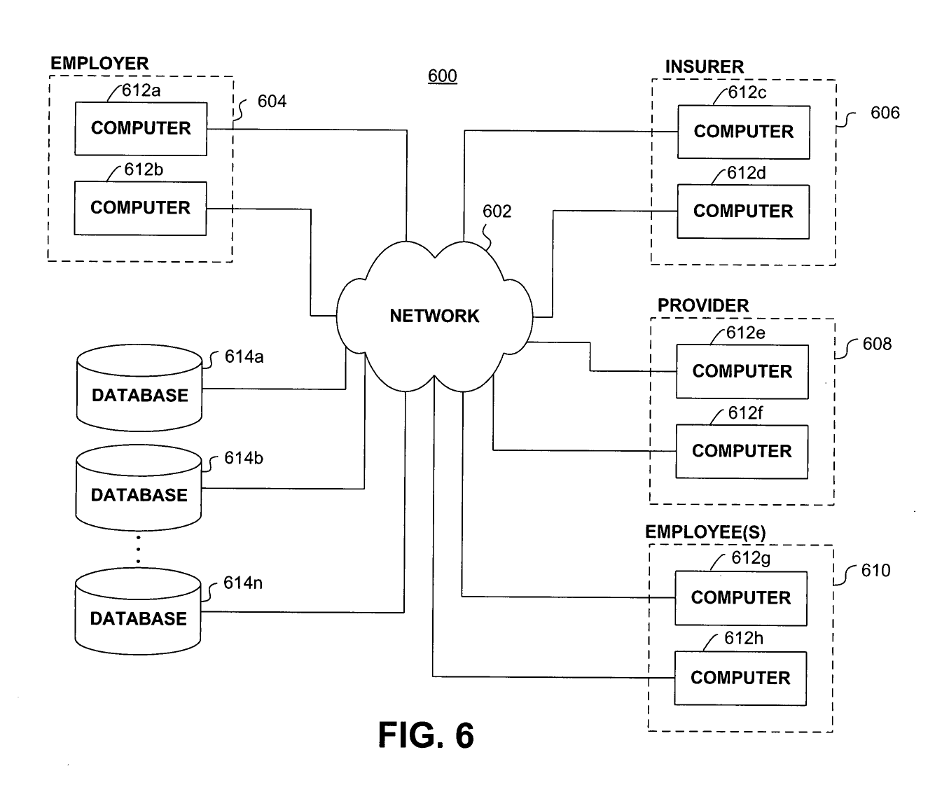

FIG. 6 is a block diagram showing an example of a computer network system 600, according to an embodiment of the invention. In FIG. 6, a network 602 connects multiple computers, including computers from an employer 604, an insurer 606, a provider 608 (e.g., a healthcare provider, physician, dentist, etc.), and one or more employees 610. The one or more employees 610, according to one or more embodiments of the invention, can be members of a healthcare plan administered by a healthcare plan administrator, such as the employer 604 or the insurer 606, and can be assigned various diagnostic groupings (e.g., MCGs), similarly to the individuals 308 shown in FIG. 4, and described in connection therewith.

The network 602 can include one or more conventional networks configured to communicate data between one or more devices, such as the Internet or other Internet Protocol (IP) network, a local area network (LAN), a wide area network (WAN), a wireless LAN (WLAN), or other suitable network. Each computer 612a-612h shown in FIG. 6 can be a general personal or business computer, a specialized computation device (e.g., a device using an embedded processor or application specific integrated circuit, or ASIC, etc.), or other processor-driven device. Additionally, any other computing device capable of transmitting and receiving (and performing analysis computing, if necessary) can be used as a computer 612 on the network.

Each entity shown in FIG. 6 (i.e., the employer 604, the insurer 606, the provider 608, and the one or more employees 610) can utilize one or more computers 612 (or suitable computation/communication device) to access the network 602, and analyze data transmitted thereby. It will be recognized that, although only two computers are shown for each entity, each entity 604, 606, 608, 610 could utilize more or fewer computers, depending upon the need of the specific entity.

Also connected to the network 602 are one or more databases 614a-614n. The number of databases connected to the network 602 can vary, and can be more or fewer than those shown in FIG. 6, depending upon the services to be offered via the network 602, the storage capacity required to provide those services, and/or the type or amount of information to be provided by way of the network 602. Although the databases 614 are shown as being essentially co-located in FIG. 6, they each can be individually collocated with one of the entities 604, 606, 608, 610 illustrated in FIG. 6. Additionally, each of the databases 614 can be remote from any of the entities 604, 606, 608, 610 illustrated in FIG. 6, and accessed only remotely via the network 602. It should also be recognized that although a description of information provided via the network 602 will be discussed below, at least some of that information could be provided by other means, other than via the network 602. It will also be recognized that devices other than those shown in FIG. 6 can be connected via the network 602 to communicate with other device connected thereto. Moreover, all entities and devices shown in FIG. 6 need not be connected to the network 602 in all cases for the network system 600 to function properly.

According to one or more embodiments of the invention, the employer 604 can communicate with an insurer 606 and/or a provider 608 via the network 602. One or more employees 610 can also be in communication with the employer 604, the insurer 606, and/or the provider 608, either via the network 602 or otherwise. The employer 604 can communicate with the insurer 606 to maintain and/or modify healthcare benefits information or parameters of a healthcare plan administered by the insurer 606. Information regarding the specifics of the healthcare plan can be stored in one or more databases 614. This information can be updated and accessed as necessary by the employer 604, or as permitted, by other entities, such as the insurer 606 and/or one or more employees 610.

According to one or more embodiments, an employee 610 may visit a provider 608 to receive healthcare under a healthcare plan maintained by the employer 604 and underwritten by the insurer 606. The provider 608 can provide diagnosis information, such as diagnostic codes (e.g., ICD codes). Generally, the provider 608, such as a physician, will provide multiple diagnostic codes to characterize the condition or conditions of the employee 610. For example, the provider 608 can provide a primary diagnostic code, a secondary diagnostic code, and a tertiary diagnostic code for one or more conditions with which the employee 610 is diagnosed.

Diagnostic codes from the provider 608 can be provided to the insurer 606, so that the insurer 606 can pay any associated insurance claims to the provider 608. (The employee 610 could, depending upon the healthcare plan maintained by the employer 604, have an “out-of-pocket” payment in the form of a co-payment, co-insurance, or deductible.) If the claim submitted by the provider 608 is allowed by the insurer 606 under the healthcare plan administered by the employer 604, then the claim can be paid to the provider 608. This payment can be accomplished electronically via the network 602, or by other means.

Historical information regarding the diagnosis of the employee 610 by the provider 608 can be stored by the insurer 606 in one or more databases 614. Historical data may include, for example, one or more diagnostic codes (e.g., ICD codes) with which an employee 610 is diagnosed, amounts of insurance claims paid by the employer 604 related to the diagnostic codes, amounts of co-payments made by the employee 610, and other medical health benefits costs associated with the diagnostic codes. Additionally, the historical information can include other information, such as dental benefits costs, vision benefits costs, disability benefits costs (e.g., long-term or short-term), workers compensation costs, benefits administration fees, pharmacy/drug costs, the costs to the employer 604 associated with the employee's absence because of a condition related to the diagnostic codes, or other healthcare-related costs.

The historical information can be provided to an employer 604 via the network 602 or by other means. Additionally, or alternatively, the insurer 606 can store such historical information of the employee 610 in one or more databases 614. This information can also be made available to an employer 604, for purposes of analysis, or use in a program, such as a disease management program, for example. Also, as desired and as permitted by relevant regulations, some or all of this historical information can optionally be made available to the provider 608 and/or the employee 610.

According to one or more embodiments of the invention, the historical information, such as any corresponding medical health benefits information (including costs) and any other healthcare-related information (including costs), can be used by the employer 604 in forming MCGs, and in analyzing the condition of the one or more employees 610. Similarly, if the insurer 606 is provided with access to the same type of information, the insurer 606 can use that information to perform similar analysis using MCGs.

The employer 604 and/or the insurer 606 can also use the diagnostic and historical information combined with other information communicated via the network 602 to form a comprehensive view of the comprehensive cost of an individual under a healthcare plan. Specifically, a total cost for that individual can be determined, by combining both medical health benefits costs and other healthcare-related costs to form a total or comprehensive health benefits cost associated with the individual (e.g., the employee 610). This information can be used to analyze the overall condition of the employee 610, and the overall cost of the individual 610 to a healthcare plan (e.g., which may be administered by the employer 604 or the insurer 606).

Moreover, the employer 604 can use such diagnostic and historical information to optimize costs within the healthcare plan, and/or provide additional services, such as disease management, or the like. For example, the employer 604 can use that information in performing a disease management needs assessment and/or a disease management quality measurement. Additionally, the employer 604 can use such information to perform a disease burden benchmark comparison. Similarly, it will be understood that other types of analyses and management, can be performed using the information associated with the employee 610.

Thus, for example, an employer 604 can place an employee 610 having a chronic condition in a disease management program. The employer 604 can then monitor the progress of the disease management program on the employee 610 and the employee's chronic condition (e.g., by monitoring the number of medical visits and corresponding number and type diagnostic codes), and on the costs associated with that employee that are related (either directly or indirectly) to the condition of the employee 610.

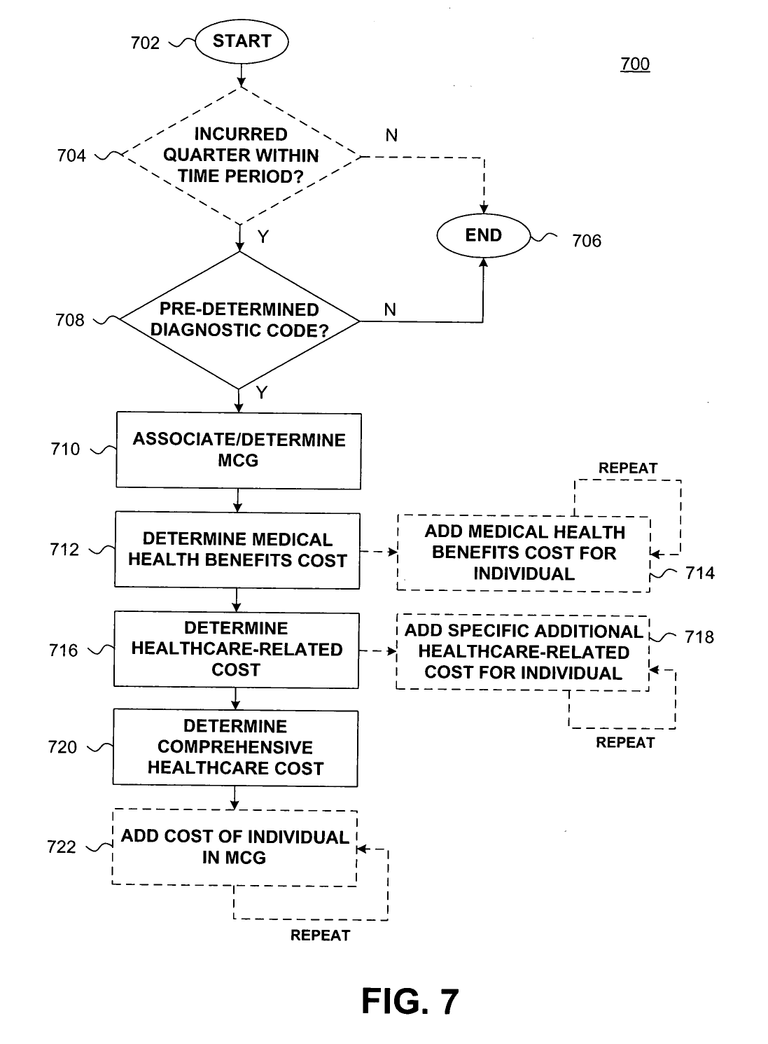

FIG. 7 is a flow diagram of a process 700, according to an embodiment of the invention. Various steps of the process 700 shown in FIG. 7 are illustrated using dashed lines, indicating that these steps are optional according to one or more embodiments of the invention. According to one or more other embodiments of the invention, one or more steps can optionally be omitted to achieve desired results. Moreover, additional steps can be added to the process 700 shown in FIG. 7, to achieve other desired results. Additionally, the order with which one or more of the steps illustrated in FIG. 7 is executed can be altered, according to the desired performance of the process 700 of that figure.

The process 700 shown in FIG. 7 begins at step 702, and optionally analyzes, in optional step 704, whether a diagnosis code has been recorded or submitted for an individual over a predetermined time period. For example, if the predetermined period is a year, a determination is made regarding whether or not a diagnosis code has been recorded or submitted over the prior year for that individual. This can be accomplished, for example, by using the concept of “incurred” periods corresponding to periods in which a diagnostic code has been “incurred” by a member. For example, if a diagnosis has been made (and/or recorded or submitted) within a prior quarter, that quarter would be considered an “incurred” quarter. Thus, if the predetermined time period is, for example, the prior four fiscal quarters, the inquiry in optional step 704 would determine whether or not there was an incurred quarter within the prior four fiscal quarters. Of course, the length of the predetermined time period can be varied, as can the increment analyzed, using any desirable time period, such that months, weeks, or days can be used instead of quarters. Likewise, any number of those time increments can make up the predetermined time period, according to the desired performance of the process 700.

If it is determined in step 704 that no diagnostic code has been recorded or submitted for an individual over a predetermined time period (e.g., there has been no incurred quarter within a predetermined time period of interest), then the process 700 of FIG. 7 can end in step 706. Alternatively, if it is determined that a diagnostic code has been recorded or submitted for an individual over a predetermined time period (e.g., there has been an incurred quarter within a predetermined time period of interest), the process 700 can continue in step 708.

A determination can be made in step 708, regarding whether one or more diagnostic codes associated with an individual (e.g., a member), is a predetermined diagnostic code. For example, in step 708 it can be determined if a diagnostic code causing an incurred quarter, as determined in optional step 704, is a diagnostic code of interest. More specifically, the determination made in step 708 can determine whether one or more predetermined diagnostic codes (e.g., a diagnostic code of interest to a healthcare plan provider or administrator) corresponding to one or more predefined MCGs has been associated with an individual (e.g., a member). If not, the process ends in step 706. If one or more of the predetermined diagnostic codes has been recorded or submitted for an individual during the predetermined period, however, the individual can then be associated with the corresponding one or more MCGs (or, in other words, one or more MCGs can be determined from the diagnostic code or codes) in step 710. It should be recognized that steps 708 and 710 can alternatively be performed after step 712 and/or step 716, discussed below, if desired.

Once an individual (e.g., a member) diagnosed with one or more diagnostic codes of interest has been grouped in one or more MCGs, the process 700 can perform various operations on various information associated with the individuals of the one or more MCGs 700. For example, according to one or more embodiments of the invention, the process 700 can determine a total cost, or comprehensive cost, of clinically related conditions (e.g., a total cost for an MCG). The comprehensive cost can include, for example, a total medical health benefits cost and one or more other healthcare-related costs. Additionally, or alternatively, medical health benefits or one or more other healthcare-related costs associated with a specific clinical condition or clinically related conditions can be individually analyzed.

According to one or more embodiments of the invention, a medical health benefits cost can be determined in step 712 for an individual. This information can optionally be used in optional step 714 to determine a total medical health benefits cost for a specific clinical condition or a group of clinically related conditions (e.g., for members diagnosed with a specific condition or group of conditions). For example, in optional step 714, a medical health benefits cost can be added for each individual in a given MCG, and this step can be repeated until the medical health benefits cost for each of the individuals in the MCG of interest have been added. Thus, using optional step 714, a total medical health benefits cost for a condition or a group of clinically related conditions (e.g., defined by an MCG) can be determined.

In step 716, a healthcare-related cost (e.g., a cost other than a medical health benefits cost) is determined for the individual. Once a healthcare-related cost has been determined in step 716, a specific healthcare-related cost can be determined in optional step 718 by adding that specific healthcare-related cost for each individual (e.g., a member) within an MCG. This optional step 718 can be repeated for each individual in the MCG to obtain a total healthcare-related cost for all individuals within an MCG. Using optional step 718, a healthcare plan administrator can focus on specific costs incurred by a member or group of members within a single MCG. For example, if pharmacy costs are of particular interest for a clinically related group, a healthcare administrator can sum all of the pharmacy costs for each individual within a specific MCG. Likewise, the total of another healthcare-related cost, such as disability benefits, for a target MCG can be summed in optional step 718, and repeated for each individual within the MCG, to determine the total cost of disability benefits for all members within the MCG. Additionally or alternatively, a group of healthcare-related costs for individuals (e.g., several or all of the healthcare-related costs) within one or more MCGs can be added to obtain a total healthcare-related cost for all of the individuals.

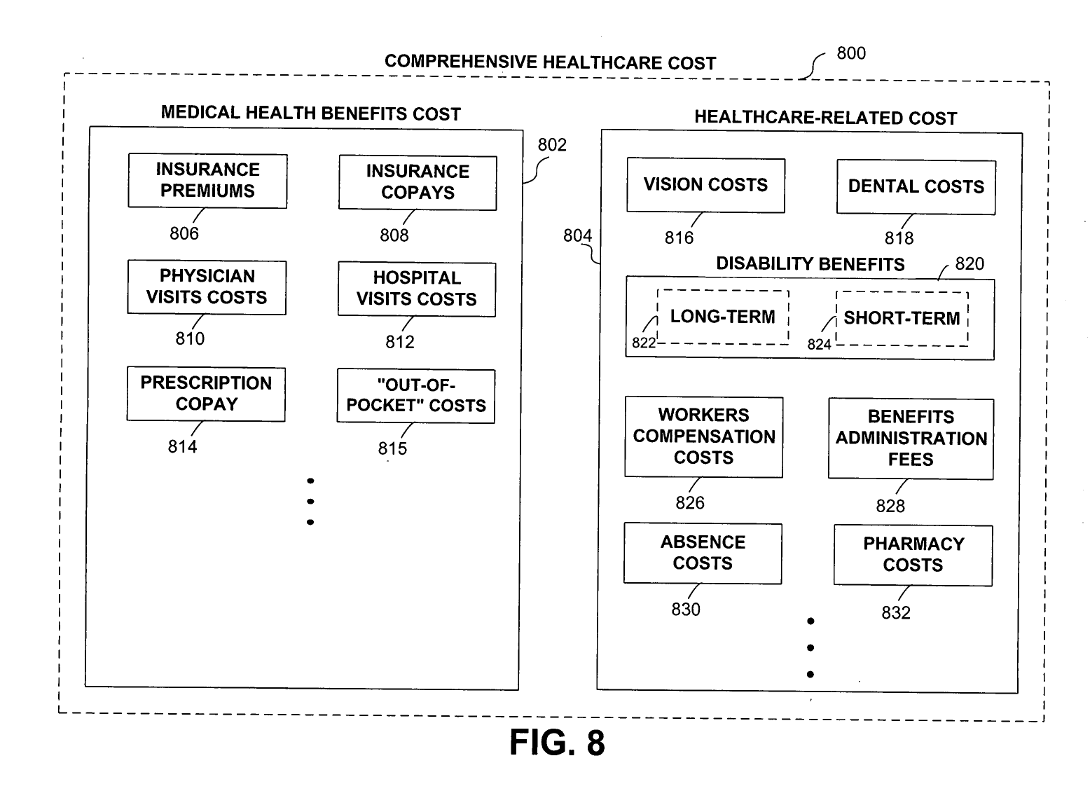

Although each of the costs determined in steps 712 and 716 are referred to herein as singular costs, they can represent a plurality of costs (e.g., sub-costs), according to one or more embodiments of the invention. Examples of these costs are described below with reference to FIG. 8.

FIG. 8 is a block diagram showing an example of a comprehensive healthcare cost 800, including examples of a medical health benefits cost 802 and a healthcare-related cost 804, according to one or more embodiments of the invention. The medical health benefits cost 802 and the healthcare-related cost 804, shown in FIG. 8 can be determined in step 712 and step 716, respectively, of the process 700 shown in FIG. 7.

As shown in FIG. 8, a medical health benefits cost 802 can include such costs as insurance premiums 806, insurance co-payments 808, physician visits costs 810, hospital visits costs 812, prescription co-payments 814, or similar medical health benefits costs directly related to a condition corresponding to one or more diagnosis codes incurred by a healthcare plan member. Additionally, the medical health benefits cost 802 can include costs incurred by a healthcare plan provider (e.g., an employer, etc.) or others, including “out-of-pocket” costs 815, which can include, for example, co-payment, co-insurance, or deductible costs.

Also, as shown in FIG. 8, a healthcare-related cost 804 can include such costs as, vision costs 816, dental costs 818, disability benefits 820 (which can include long-term disability benefits costs 822 and/or short-term disability benefits costs 824), workers compensation costs 826, benefits administration fees 828, absence costs 830 (e.g., the costs to an employer for an employee's time away from the office), pharmacy costs 832, and similar healthcare-related costs.

Turning again to FIG. 7, after both the medical health benefits cost 802 (shown in FIG. 8) and the healthcare-related cost 804 (shown in FIG. 8) have been determined in step 712 and step 716, respectively, the costs can be combined in step 720 to determine a comprehensive healthcare cost 800 (shown in FIG. 8). Of course, the order of steps 712 and 716 can be reversed, if desired, without changing the comprehensive healthcare cost 800. According to one or more embodiments of the invention, the medical health benefits cost and healthcare-related cost determined in step 712 and step 716, respectively, are each determined for each individual in an MCG. Thus, the resulting comprehensive healthcare cost determined in step 720 is the comprehensive healthcare cost for an individual within an MCG.

In optional step 722, the cost of each individual in the MCG can be added to obtain a total cost for all of the individuals (e.g., a total of all comprehensive healthcare costs associated with each individual) within the MCG. By obtaining, in optional step 722, a total cost for all individuals within a single MCG, the process 700 can advantageously convey the comprehensive healthcare cost for a healthcare plan provider (e.g., an employer) associated with individuals that have been diagnosed with one or more clinically related diagnostic codes. Additionally, or alternatively, this information can advantageously be segmented at the individual level, if desired.

According to one or more embodiments of the invention, one or more of the later steps 712-722 can be used separately from the earlier steps 702-710 in FIG. 7. For example, where groupings of members (e.g., MCGs) already exist, the determination of a comprehensive healthcare cost and/or analysis of one or more costs (e.g., medical health benefits cost, healthcare-related cost, etc.) can be performed independently from determination of the grouping. For example, an analysis can be performed, using optional step 718 to determine a healthcare-related cost for all individuals within an existing MCG, where MCG information has already been determined or provided. Additionally, or alternatively, a total cost of an individual (e.g., a comprehensive healthcare cost of an individual) can be determined in step 722, using existing MCG information that has been provided, without the need to determine the members of the MCG.

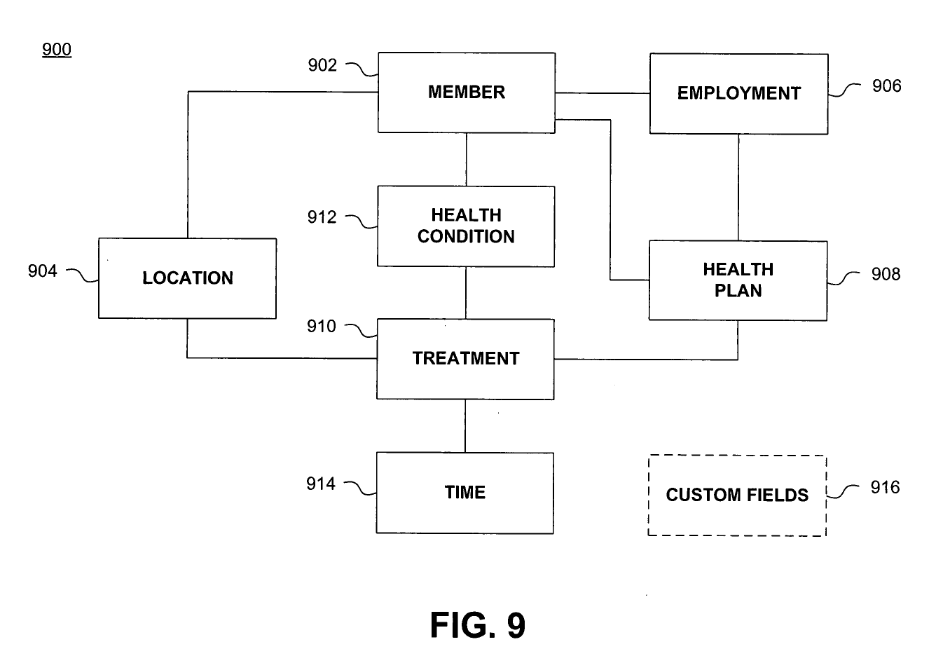

FIG. 9 is a block diagram of a data model 900, according to an embodiment of the invention. The data model 900 shown in FIG. 9 is a simplified model of a relational database configuration for utilizing MCGs in a healthcare plan context. Costs of members that are grouped in an MCG (e.g., in step 710 of FIG. 7) can be analyzed using analysis and/or management tools, such as the data model 900 shown in FIG. 9, or tools using such a data model 900. It should be recognized that FIG. 9 is intended to illustrate only one possible implementation, and elements not shown in the data model 900 can be added and/or elements shown in the data model 900 can be removed, depending upon the specific requirements for a healthcare plan. Moreover, relationships between various elements, or entities, within FIG. 9 can be added to or deleted from the simplified data model 900 illustrated in FIG. 9, and can include one-to-one, one-to-many, and/or many-to-many relationships depending upon the specific data tables used and the desired function of the system. Additionally, it should be recognized that each entity illustrated in FIG. 9 can include multiple dimensions (e.g., multiple data tables) which can be interconnected or otherwise interrelated in many different ways. Data tables within an entity of the data model 900 can be in the form of informational tables (e.g., tables that store discrete information about an aspect of the corresponding entity), relational tables (e.g., tables that relate information contained in multiple tables, such as look-up tables), or other convenient formats.

In the data model 900 of FIG. 9, multiple entities are illustrated having various interconnected relationships. A member entity 902 is shown relating to numerous other entities, including a location entity 904, an employment entity 906, a health-plan entity 908, and a health-condition entity 912, each of which is described below.

The member entity 902 represents all relevant personal information of a member within a healthcare plan. For example, the member entity 902 can include multiple dimensions and/or multiple data tables (each of which is configured to be populated with relevant information necessary for any desired analysis using the data model 900). The member entity 902 can include, for example, a member dimension, which can include information relating to a member's MCGs, gender, salary, disability status, and so forth. The information of the member dimension can be stored in one or more data tables. For example, according to one or more embodiments of the invention, the member dimension can include a member-group data table configured to relate a diagnostic code (e.g., a diagnostic code from the health-condition entity 912, described below) with an MCG of clinically related diagnostic codes. The member dimension of the member entity 902 can also include at least one data table configured to store, on an individual-member-basis, medical health benefits cost 802 (shown in FIG. 8) information and/or other healthcare-related cost 804 (shown in FIG. 8) information for each MCG associated with the member.

The member entity 902 can also include an age dimension, which can include information relating to a member's age, and can, according to one or more embodiments of the invention, categorize a member within one or more age groups or sub-groups. Additionally, the member entity 902 can also include a relation-type dimension that specifies relationships unique to a member, such as between the member and an employer, or the like.

A location entity 904 is related to the member entity 902, and is also related to a treatment entity 910, described below. The location entity 904 can include a geography dimension, which includes data tables that identify a geographic location of a member (e.g., city, state, and zip code information, etc.). Additionally or alternatively, the location entity 904 can include a service-location dimension that includes similar geographic information specific to a service location where treatment is received by a member, and which could include, for example, Medicare or Medicaid participant information, or other important information associated with a service location.

An employment entity 906 is related to the member entity 902, and is also related to a health plan entity 908, described below. The employment entity 906 can include, for example, an employment-status dimension and an employer dimension. The employment-status dimension can, for example, include data tables configured to store information regarding whether or not an employee (e.g., a member) is a full-time or part-time employee, or if an employee has been laid-off. This information may be important, for example, in determining premium and co-payment amounts, which may be significantly different for a member who has been laid-off (e.g., a member who is now covered by a Consolidated Omnibus Budget Reconciliation Act, or COBRA, plan, etc.). The employer dimension can contain information specific to the employer (e.g., a plan administrator or sponsor), and can contain information relating the employer to an employee (e.g., a member), such as data tables containing the employee's primary and secondary business units within the employer's company. This information can be used, for example, to determine the types of benefits available to the member, if benefits vary by business unit or type of employment, for exmple.

A health-plan entity 908 relates to the member entity 902, the employment entity 906, and a treatment entity 910, described below. The health-plan entity 908 can include a coverage dimension, a claim dimension, a charge-type dimension, a provider dimension, an insurance-plan dimension, and a pharmacy dimension. The coverage dimension, claim dimension, and charge-type dimension can include, for example, one or more data tables storing coverage-type information, claim information, and charge-type information, respectively. A provider dimension can include information about a provider used under a healthcare plan, such as specialty information and provider-type information. This information can be used, for example, to analyze the validity of diagnosis codes received from a provider, or to analyze costs for different types of providers (e.g., doctor versus dentist, specialist versus generalist, “in-plan” versus “out-of-plan,” etc.). The insurance-plan dimension can include data tables storing information regarding an insurance carrier, such as whether the plan is a health maintenance organization (HMO) or not, what the type of the insurance plan is, any insurance sub-plan information, if applicable, and the like. The pharmacy dimension can include information regarding specific pharmacies, such as the types of those pharmacies, or other relevant information.

A treatment entity 910 relates, as discussed above, to the location entity 904 and the health-plan entity 908, and also relates to a health-condition entity 912, and a time entity 914, each of which is described below. The treatment entity 910 can include information from a variety of dimensions, including a medical-encounter dimension, a surgical-procedure dimension, a medical-intervention dimension, and a drug dimension. The medical-encounter dimension and surgical-procedure dimension include data tables configured to store data regarding a medical encounter and a surgical procedure (e.g., ICD or ICD-9 codes relating to a performed surgical procedure), respectively. The medical-intervention dimension can include data tables that are configured to store information regarding medical-intervention treatment programs. The drug dimension can include data tables configured to store information about drugs used by a member, such as a drug name, a therapeutic category, national drug classification (NDC) information, equivalent drugs, brand or generic information, or other desired information. The treatment entity 910 allows for analysis of costs of various aspects of treatment, as well as the effectiveness (or ineffectiveness) of intervention programs.

A health-condition entity 912 relates to the member entity 902 and the treatment entity 910. The health condition entity 912 can include a health-condition dimension that has data tables that are interrelated and configured to store information related to EDCs, MEDCs, MEDC types, ICDs, ADGs, collapsed ADGs (CADGs), a duration of an ADG, other diagnostic codes, ADG etiology information, special care needs information, and other desired healthcare information. For example, the health-condition dimension of the health-condition entity 912 can include multiple diagnostic codes for each member to which it relates via the member entity 902. Various known codes can be used to enter information about a member's condition, such as information from the data tables of the health-condition entity 912. This information, which is all interrelated, can then be parsed and used to determine an individual's MCG in a data table within the member entity 902. According to one or more embodiments of the invention, all of the information in the data tables of the health-condition entity 912 relate to an individual (e.g., a member), and can, therefore, be segregated on an individual basis.

A time entity 914 is related to the treatment entity 910. The time entity 916 includes all time information in a time dimension. Information within the time dimension can be stored in a number of data tables configured to store and relate information regarding time periods, such as day, month, quarter, year, fiscal month, fiscal quarter, fiscal year, month of the year, and predetermined time periods (e.g., a rolling 12-month period, a rolling 4-quarter period, etc.). Using the predetermined time periods, a healthcare plan administrator can analyze all costs, claims, and/or data within a previous predetermined window of time (e.g., the previous 12 months, the previous 4 quarters, etc.).

In addition to those entities discussed above, one or more optional entities can also form part of the data model 900 shown in FIG. 9. For example, the data model 900 can include a number of configurable, optional custom fields, represented by a custom-fields entity 916, which allow an administrator to store and relate data (e.g., between the other entities, or between the other entities, and external interfaces to the data model 900) in any number of desired ways. For example, the custom diagnostic group described above in connection with Table 1 (for defining a premature infants MCG) can be implemented using one or more custom data tables from the optional custom-fields entity 916 to store customized diagnostic code information and relate that information to an MCG table for an individual member, stored in the member entity 902. Additionally, other relational tables can be added to relate information between any set of data tables.

From the foregoing, it can be seen that systems and methods for developing and utilizing member condition groups (MCGs) are discussed. MCGs are advantageous over prior methodologies for several reasons. For example, MCGs facilitate analysis of healthcare conditions and healthcare-related costs on an individual basis and by disease condition. Additionally, MCGs also provide the ability to determine and analyze a comprehensive healthcare cost associated with each individual (e.g., member) in a benefit group (e.g., a healthcare plan), for example. Specific embodiments have been described above in connection with a specific process, system, and data model. Specific examples of MCG definitions have also been provided to facilitate understanding.

It will be appreciated, however, that embodiments of the invention can be in other specific forms without departing from the spirit or essential characteristics thereof. For example, while some embodiments have been described in the context of certain processes, systems, or data models, the form of each of these can be changed within the context of the invention. For example, although specific examples of MCG definitions have been given relative to EDCs, those definitions can also be determined using ICD codes or other clinical markers. Additionally, other diagnostic codes can also be used to define the MCGs described above. Furthermore, it will be appreciated that the examples of MCGs provided above are not all-inclusive, and additional MCGs can be developed and utilized according to one or more embodiments of the invention, and the principles thereof.

It will be recognized that many components and/or steps of the invention can be implemented interchangeably in software or hardware, or using a suitable combination of both. Additionally, the order of steps of a process can be interchanged within the context of the invention. The presently disclosed embodiments are, therefore, considered in all respects to be illustrative and not restrictive.

1. A processor-readable medium comprising code representing instructions to cause a processor to:
determine, for each individual from a predetermined plurality of individuals, if that individual has been diagnosed with one or more diagnostic codes from a predetermined plurality of diagnostic codes;
associate each diagnosed individual with one or more member condition groups (MCGs) based on the one or more diagnostic codes with which the individual has been diagnosed, each MCG representing a group of individuals diagnosed with clinically related diagnostic codes; and
determine a healthcare-related cost associated with each diagnosed individual associated with a predetermined MCG during a predetermined time period, the healthcare-related cost including at least one cost selected from a group including a pharmacy cost, a disability benefit, a workers compensation benefit, a health benefit administration fee, and an absence cost.

2. The processor-readable medium of claim 1, wherein the one or more diagnostic codes from the plurality of diagnostic codes include an international classification of diseases code.

3. The processor-readable medium of claim 1, further comprising code representing instructions to cause a processor to:
determine a healthcare-related MCG cost for each of the one or more MCGs by combining healthcare-related costs associated with each of the diagnosed individuals within each of the one or more MCGs.

4. The processor-readable medium of claim 1, further comprising code representing instructions to cause a processor to:
determine a healthcare-related MCG cost for each of the one or more MCGs having healthcare-related costs associated with a predetermined pharmacy cost by combining each of the healthcare-related costs associated with each of the diagnosed individuals associated with the predetermined pharmacy cost within each of the one or more MCGs.

5. The processor-readable medium of claim 1, further comprising code representing instructions to cause a processor to:
determine a medical health benefits cost associated with each diagnosed individual from the predetermined MCG during the predetermined time period, the medical health benefits cost being distinct from the healthcare-related cost; and
combine the medical health benefits cost and the healthcare-related cost to determine a comprehensive healthcare cost associated with each diagnosed individual.

6. The processor-readable medium of claim 5, further comprising code representing instructions to cause a processor to:
determine an MCG total cost for each of the one or more MCGs by combining each of the comprehensive healthcare costs associated with each of the diagnosed individuals within each of the one or more MCGs.

7. The processor-readable medium of claim 5, further comprising code representing instructions to cause a processor to:
determine an MCG total cost for each of the one or more MCGs associated with a predetermined pharmacy cost by combining each of the comprehensive healthcare costs associated with each of the diagnosed individuals within each of the one or more MCGs having at least one diagnosed individual associated with the predetermined pharmacy cost.

8. A method, comprising:
determining, for each individual from a predetermined plurality of individuals, if that individual has been diagnosed with one or more diagnostic codes from a predetermined plurality of diagnostic codes;
associating each diagnosed individual with one or more member condition groups (MCGs) based on the one or more diagnostic codes with which the individual has been diagnosed, each MCG representing a group of individuals diagnosed with clinically related diagnostic codes; and
determining a healthcare-related cost associated with each diagnosed individual associated with a predetermined MCG during a predetermined time period, the healthcare-related cost including at least one cost selected from a group including a pharmacy cost, a disability benefit, a workers compensation benefit, a health benefit administration fee, and an absence cost.

9. The method of claim 8, wherein the one or more diagnostic codes include an international classification of diseases code.

10. The method of claim 8, further comprising:
determining a medical health benefits cost associated with each diagnosed individual from the predetermined MCG during a predetermined time period, the medical health benefits cost and the healthcare-related cost being distinct; and
combining the medical health benefits cost and the healthcare-related cost to determine a comprehensive healthcare cost associated with the individual.

11. The method of claim 10, further comprising:
determining an MCG total cost for each of the one or more MCGs by combining each of the comprehensive healthcare costs associated with each of the diagnosed individuals within each of the one or more MCGs.

12. The method of claim 11, wherein the MCG total cost is used in a disease management program to analyze a benefit of a treatment under the disease management program.

13. The method of claim 11, wherein the MCG total cost is used in a benefits modeling program.

14. The method of claim 10, further comprising:
determining an MCG total cost for each of the one or more MCGs by combining each of the comprehensive healthcare costs associated with each of the diagnosed individuals having a predetermined healthcare-related cost.

15. The method of claim 10, further comprising:
determining an MCG total cost for each of the one or more MCGs associated with a predetermined pharmacy cost by combining each of the comprehensive healthcare costs associated with each of the diagnosed individuals within each of the one or more MCGs.

16. The method of claim 10, wherein the medical health benefits cost includes at least one medical claims cost from a primary diagnostic code, a secondary diagnostic code, and a tertiary diagnostic code.

17. The method of claim 8, wherein the healthcare-related cost includes at least one of vision costs and dental costs.

18. The method of claim 8, wherein the predetermined time period includes a predetermined number of incurred quarters, each incurred quarter from the predetermined number of incurred quarters including a date on which at least one of a medical health benefits cost and a healthcare-related cost is incurred.

19. A data model, comprising:
at least one member data table configured to store data representing a plurality of members of a healthcare plan;
at least one health-condition data table configured to store data representing health-condition information of each member from the plurality of members, the health-condition information being configured to include a plurality of diagnostic codes for each member from the plurality of members; and
at least one member-group data table configured to relate, for each member, a diagnostic code from the plurality of diagnostic codes to a member condition group (MCG) of clinically related diagnostic codes, if it is determined that the diagnostic code includes a predetermined diagnostic code.

20. The data model of claim 19, further comprising:
at least one data table configured to store on an individual-member-basis medical health benefits cost information for each MCG associated with each member from the plurality of members; and
at least one data table configured to store on an individual-member-basis healthcare-related cost information for each MCG associated with each member from the plurality of members.

21. A method, comprising:
determining a medical health benefits cost associated with an individual during a predetermined time period;
determining an additional healthcare-related cost not included in the medical health benefits cost, the additional healthcare-related cost being associated with the individual during the predetermined time period, the additional healthcare-related cost including at least one cost selected from a group including a disability benefit, a workers compensation benefit, a health benefit administration fee, and an absence cost; and
combining the medical health benefits cost and the additional healthcare-related cost to determine a comprehensive healthcare cost associated with the individual.
